(19) United States
(12) Patent Application Publication
(10) Pub. No.: US 2006/0134514 A1
(43) Pub. Date: Jun. 22, 2006

(54) Battery including a plurality of cells placed side by side in a case

(75) Inventors: Pierre Lenain, Arras (FR); Veronique Le Rhun, Arras (FR)

Correspondence Address: YOUNG & THOMPSON, 745 SOUTH 23RD STREET, 2ND FLOOR, ARLINGTON, VA, 22202, US

(73) Assignee: HAWKER SARL, ARRAS (FR)

(21) Appl. No.: 11/300,420

(22) Filed: Dec. 15, 2005

(30) Foreign Application Priority Data
Dec. 17, 2004 (FR) 0413529

(51) Int. Cl. H01M 10/50; H01M 2/24

(52) U.S. Cl. 429/120; 429/156; 429/159

(57) ABSTRACT

Battery (1) of the type including a plurality of cells (3) placed side by side in a case (2), in which the cells (3) are separated from each other and from the walls (11, 12) of the case (2), at least on some of their sides, by sheets (6, 9, 10) of a material presenting a thermal conductivity in its plane greater than 250 W/m.k and a thermal conductivity through its thickness less than 20 W/m.k.

The invention relates to the field of electrical energy sources, in particular batteries for electric vehicles.

Electric vehicles use onboard energy sources that are lead-acid, nickel-cadmium, nickel-zinc, lithium, lithium-polymer, lithium-ion, and other types of secondary accumulator batteries.

A traction battery for an electric vehicle is made up of cells linked in series or in series/parallel and placed in a case in contact with each other. While the battery is charging or discharging, the heat given off by the cells causes wide temperature variations between these cells, and on their surfaces.

The temperature differences observed from one cell to another are directly linked to their positioning in the case. The cells in the middle of the case are subject to the greatest temperature rise, and consequently the direct transmission of heat between the cells.

Furthermore, the heat release on each cell taken individually takes place mainly in the top third of the cell. This means that there are temperature gradients on the very surfaces of the cells, with, in addition, localized temperature peaks. These cause differences in the coupling of the active matter on the surface of the electrodes. They can result in premature ageing of the electrodes, and therefore degraded performance of the cells.

To improve the evacuation of the heat produced by the cells, interposing corrugated walls between the latter to form cooling channels, together with openings provided in the case in which the cells are positioned (see document FR-A-2 210 018), has been considered. However, to be effective, such a solution preferably requires the addition to the case of means providing forced air circulation. This makes the installation take up more room and/or takes away from the space available for the cells to provide the space required to install the cooling system. Furthermore, although this solution can be used to evacuate some of the heat produced by the cells of the battery, it is not very effective in reducing the non-uniformities of temperature on their walls. Lastly, the battery itself is used as a generator to operate the fans, which consumes energy.

The object of the invention is to propose a battery design made up of a plurality of cells placed in a case in such a way as to best resolve these thermal uniformity problems.

To this end, the subject of the invention is a battery of the type including a plurality of cells placed side by side in a case, characterized in that said cells are separated from each other and from the walls of the case, at least on some of their sides, by sheets of a material presenting a thermal conductivity in its plane greater than 250 W/m.K and a thermal conductivity through its thickness less than 20 W/m.K.

At least some of said sheets can extend between the narrow sides of the case.

At least some of said sheets can extend between the wide sides of the case.

According to a variant of the invention, at least some of said sheets are independent of the cells and of the walls of the case.

Said independent sheets can extend uninterrupted between two opposite walls of the case.

According to another variant of the invention, at least some of said sheets cover the outer walls of the cells and of the walls of the case.

Said material can be graphite.

As will have been understood, the invention consists in providing, in the battery case, sheets separating cells, these sheets having the property of presenting on the one hand a high thermal conductivity in the direction of their plane, and on the other hand of very significantly lower thermal conductivity in the direction of their thickness.

These separating sheets can be independent of the cells and positioned between them when the battery is assembled. They can also be fixed to the walls of the cells, or even also to the walls of the case, before the cells are installed.

In this way, the separating sheets even out the temperature over the height of the cells, and also between the cells that are in contact with one and the same side of one and the same sheet.

Moreover, they prevent the heat given off by one cell from propagating excessively towards the facing cell. Thus, they significantly reduce the build-up of heat on the cells located at the centre of the case, as is normally observed.

Materials that can be used for these separating sheets normally present a laminar structure. Among these, graphite is a preferred example. Its thermal conductivity in the plane can be as high as 370 W/m.K (therefore approximating to that of metals such as aluminium and copper), and can be just 6.5 W/m.k through its thickness. It therefore presents an extremely marked thermal anisotropy that would not be found on metallic sheets. This anisotropy is very well suited to the role required of the separating sheets according to the invention. Furthermore, it is a material that is easy to work and commonly available.

The invention will be better understood from reading the description that follows, given with reference to the following appended drawings:

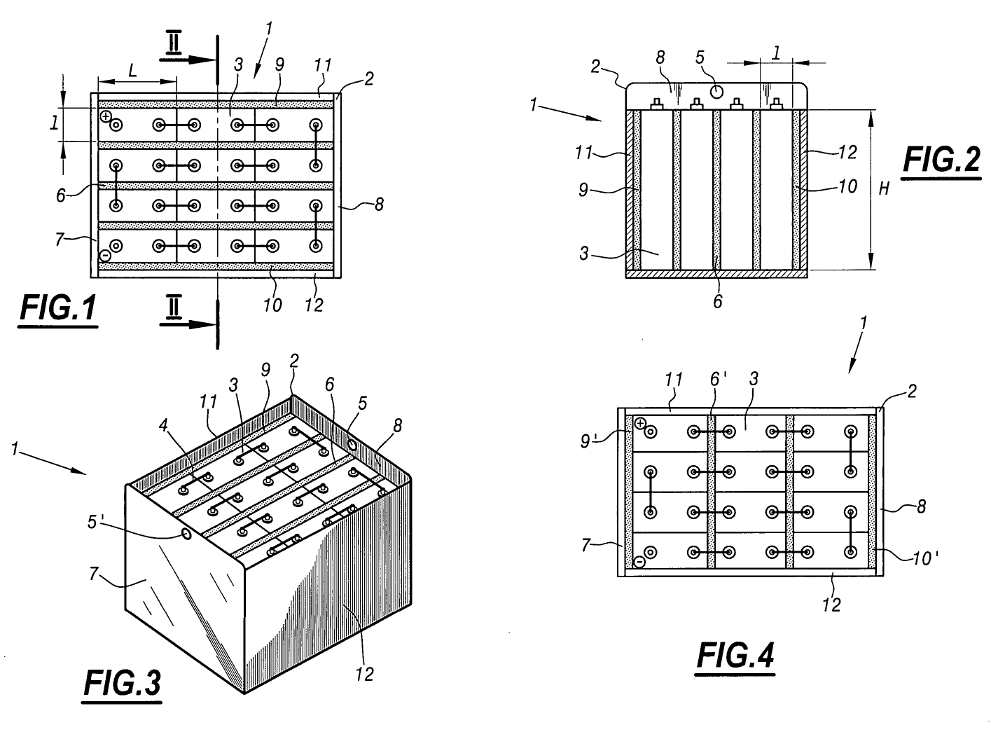

FIG. 1, which shows a plan view of an example of a battery according to the invention;

FIG. 2, which shows the same example of battery seen in transverse cross section through II-II;

FIG. 3, which shows this same example in perspective view;

FIG. 4, which shows another variant of the invention.

As can be seen from FIGS. 1 and 3, an example of battery 1 according to the invention is made up of a parallelepipedal case 2, open on its top side, in which are positioned a certain number of cells 3 (twelve in the example shown, arranged in four rows and three columns), each having, for example, an electromotive force of 2 V, and connected in series by connection means 4. Each cell 3 is parallelepipedal, of length L, of width W and of height H. The case 2 includes, in the top parts of two opposite sides, orifices 5, 5′ for handling the case. All these characteristics are perfectly conventional and require no further description.

According to the invention, the different rows of cells 3 are separated by graphite sheets 6 which extend in this example between the two narrow sides 7, 8 of the case 2. Other graphite sheets 9, 10 separate the extreme rows of cells 3 from the wide sides 11, 12 of the case 2. In the example shown, it was decided not to position graphite sheets between the columns of cells 3, and therefore between the narrow sides of the cells 3, which are therefore directly in contact with each other at this level. Nor are there graphite sheets between the extreme columns of cells 3 and the narrow sides 7, 8 of the case 2. However, of course, it would still be perfectly in accordance with the invention to provide, in addition to the graphite sheets 6, 9, 10, represented in the figures, other graphite sheets separating the narrow sides of contiguous cells 3 and the extreme columns of cells 3 and the narrow sides 7, 8 of the case 2. The choice of the positions of the graphite sheets is based on various criteria associated with the plan of the case and the space available. Normally, preference will be given, if possible, to installing sheets 6, 9, 10 between the two narrow sides 7, 8 of the case 2, to deal with the most extensive possible surface area.

In the variant shown in FIG. 4, graphite sheets 9′, 10′ are positioned along the narrow sides 7, 8 of the case 2 and graphite sheets 6′ separating the columns of cells 3. These latter sheets 6′ therefore extend between the wide sides 11, 12 of the case 2 and separate the cells 3 of one and the same row in the vicinity of their terminals. Experience shows that it is this arrangement that gives the best results from the point of view of preventing the build-up of heat in the centre of the battery 1.

Typically, the graphite sheets (6, 9, 10; 6′, 9′, 10′) each have a thickness of around 1 to 10 mm. This thickness is chosen according to the desired results and the space available in the case (particularly if the invention is to be applied to a battery not initially intended for its application).

In the examples shown, the graphite sheets (6, 9, 10; 6′, 9′, 10′) are independent of the cells 3 and of the case 2. They are placed in the case 2 when the battery is assembled. However, it is perfectly possible to provide (in addition to or in place of the independent sheets 6, 9, 10; 61, 91, 10′) for the graphite sheets to cover at least some of the outer walls of the cells and/or at least some of the walls of the case 2 before installing the cells 3 in the case 2. Such a solution presents two main advantages. If the adhesion of the graphite to the cell 3 is good and if the adhesive material used is not too good an insulator, this ensures very good heat conduction between the cell 3 and the graphite sheet. The evening of the temperature on the corresponding face of the cell 3 can only be better. Furthermore, an interface is thus created between the graphite sheets covering two facing cells 3 (or between a cell 3 and the side of the case 2 against which it is positioned). This interface helps to prevent the propagation of heat.

In the example shown, the graphite sheets (6, 9, 10; 6′, 9′, 10′) all extend from one end to the other of the case 2, uninterrupted. It would still, however, be within the spirit of the invention to replace these single sheets (6, 9, 10; 6′, 9′, 10′) with a succession of sheets, preferably contiguous. Moreover, this is what happens when graphite sheets covering the cells 3 prior to their installation in the case 2 are used.

It is also possible to complement the case 2 of the battery or its environment with devices to promote the dissipation of the heat by the graphite sheets (6, 9, 10; 6′, 9′, 10′), such as ventilation openings provided in the walls of the case 2, and/or one or more fans. It should, however, be understood that this is not essential, the primary objective of the invention being not to promote the overall cooling of the battery, but to limit its thermal gradients, on the one hand over the height of the cells 3 taken individually, and on the other hand between contiguous cells 3.

All of the above description was based on the use of graphite as the material to make the sheets (6, 9, 10; 6′, 9′, 10′). It presents the required thermal characteristics and it is easy to work. However, sheets of other materials presenting comparable thermal conductivity in their plane and thermal anisotropy could be used.

As a general rule, to implement the invention, materials presenting a thermal conductivity in their plane of at least 250 W/m.K and a thermal conductivity through their thickness of no more than 20 W/m.K are used.

The invention applies to the case of batteries made up of a number of contiguous cells placed in a case, regardless of the exact type of cells and how these batteries are used, the application to electrical vehicle traction batteries being a preferred, but by no means exclusive, example. The invention can also profitably be applied to stationary batteries. In all cases, the reduction of the thermal imbalances between the cells results in an optimized charging of the cells relative to each other and an increase in the life of the battery.

1. Battery (1) of the type including a plurality of cells (3) placed side by side in a case (2), characterized in that said cells (3) are separated from each other and from the walls (11, 12) of the case (2), at least on some of their sides, by sheets (6, 9, 10; 6′, 9′, 10′) of a material presenting a thermal conductivity in its plane greater than 250 W/m.K and a thermal conductivity through its thickness less than 20 W/m.k.

2. Battery (1) according to claim 1, characterized in that at least some of said sheets (6, 9, 10) extend between the narrow sides (7, 8) of the case (2).

3. Battery (1) according to claim 1, characterized in that at least some of said sheets (6′, 9′, 10′) extend between the wide sides (11, 12) of the case (2).

4. Battery (1) according to claim 1, characterized in that at least some of said sheets (6, 9, 10; 6′, 9′, 10′) are independent of the cells (3) and of the walls (11, 12) of the case (2).

5. Battery (1) according to claim 4, characterized in that said independent sheets (6, 9, 10; 6′, 9′, 10′) extend uninterrupted between two opposite walls (7, 8) of the case (2).

6. Battery (1) according to claim 1, characterized in that at least some of said sheets cover the outer walls of the cells (3) and/or the walls of the case (2).

7. Battery (1) according to claim 1, characterized in that said material is graphite.

8. Battery (1) according to claim 2, characterized in that at least some of said sheets (6′, 9′, 10′) extend between the wide sides (11, 12) of the case (2).

9. Battery (1) according to claim 2, characterized in that at least some of said sheets (6, 9, 10; 6′, 9′, 10′) are independent of the cells (3) and of the walls (11, 12) of the case (2).

10. Battery (1) according to claim 3, characterized in that at least some of said sheets (6, 9, 10; 6′, 9′, 10′) are independent of the cells (3) and of the walls (11, 12) of the case (2).
